(19) United States
(12) Patent Application Publication
(10) Pub. No.: US 2015/0158130 A1
(43) Pub. Date: Jun. 11, 2015

(54) Mobile Waterstop Welding Apparatus

(71) Applicant: William S. Callaway, III, Escalante, UT (US)

(72) Inventor: William S. Callaway, III, Escalante, UT (US)

(21) Appl. No.: 14/100,097

(22) Filed: Dec. 9, 2013

(51) Int. Cl. B23K 37/04

(52) U.S. Cl. CPC B23K 37/04

(57) ABSTRACT

A mobile waterstop welding apparatus includes a first and second support member for supporting a first and second waterstop section, respectively. The second support member is movable between a loading configuration, a heating configuration, and a welding configuration. In the loading configuration, the first and second support members are spaced apart so that the first and second waterstop sections may be loaded onto the first and second support members. In the heating configuration, the first and second support members are spaced apart so that a heating iron may be placed in-between respective welding ends of the first and second waterstop sections. In the welding configuration, the first and second support members are moved towards each other so as to weld the first and second waterstop sections together at their respective welding ends. During the welding process, a spring assembly may urge the first and second support members towards each other.

### BACKGROUND OF THE INVENTION

This invention relates generally to construction tools and, more particularly, to a mobile waterstop welding apparatus specifically configured to weld together two pieces of waterstop that are located at a construction site and positioned in-between or adjacent to rebar.

Waterstop may be used anywhere a fluid, such as water, may seep through a concrete joint. Concrete joints occur when concrete structures are poured in multiple stages. One such example is when a basement's concrete floor is poured and allowed to cure prior to pouring the basement's concrete walls. One or more pieces of waterstop may be embedded into the joint of the wall and the floor to prevent water from seeping into the basement at the wall-to-floor joint. Two pieces of waterstop may be welded together to prevent water from seeping therebetween.

A common practice of welding two pieces of waterstop together includes heating the ends of each piece of the waterstop until they are hot enough to be welded together. A special heating iron may be used in this heating process. Constant pressure may need to be exerted on each piece of waterstop to ensure that each end being heated maintains constant contact with the heating iron during the heating process. When the two ends are properly heated, they are removed from the heating iron and immediately butted together to begin a welding process. To ensure an effective weld, constant pressure may need to be applied to the two pieces as they are welded together.

Care must be taken to ensure that alignment of the two pieces of waterstop is maintained throughout the entire welding process. Maintaining alignment of the two pieces of waterstop can be difficult, especially when the waterstop is located at a construction site and positioned in-between or adjacent to rebar.

Various waterstop welding apparatuses have been proposed in the prior art. Although assumably effective for their intended purposes, the current devices are not capable of being used for two pieces of waterstop that are positioned in-between or adjacent to rebar and/or they do not effectively maintain alignment of the two pieces of waterstop during the welding process. Existing devices are either too large or cannot be configured into small spaces between rebar in order to quickly and efficiently weld waterstop sections at precisely the location where they are needed.

Therefore, it would be desirable to have a welding apparatus that maintains alignment of two pieces of waterstop during the welding process and is capable of being used for two pieces of waterstop that are positioned in-between or adjacent to rebar. Further, it would be desirable to have a welding apparatus capable of applying constant pressure to both pieces of waterstop during the heating process and the welding process.

### SUMMARY OF THE INVENTION

A mobile waterstop welding apparatus according to the present invention includes a first support member for supporting a first waterstop section and a second support member for supporting a second waterstop section. The second support member is operatively coupled to the first support member and is movable between a closed configuration and a variety of open configurations. The open configurations may include a loading configuration, a heating configuration, and a welding configuration. The first support member may also be movable between a closed configuration, a loading configuration, a heating configuration, and a welding configuration.

The mobile waterstop welding apparatus may also include a linkage assembly, a track assembly, and/or a spring assembly. The linkage assembly may move the first and/or second support members; the track assembly may guide the movement of the first and/or second support members; and the spring assembly may urge the first and second support members towards each other.

The mobile waterstop welding apparatus may also include a back plate and a plurality of hanging members. The plurality of hanging members may be used to selectively hang the mobile waterstop welding apparatus from rebar. The back plate may be used to prevent the rebar from interfering with the movement of the first and/or second support members.

Therefore, a general object of this invention is to provide a mobile waterstop welding apparatus that is capable of being used to weld together two waterstop sections that are located at a construction site and positioned in-between or adjacent to rebar.

Another object of this invention is to provide a mobile waterstop welding apparatus, as aforesaid, that maintains alignment of two waterstop sections during a welding process.

Still another object of this invention is to provide a mobile waterstop welding apparatus, as aforesaid, that applies constant pressure to two pieces of waterstop during the heating process and the welding process.

Yet another object of this invention is to provide a mobile waterstop welding apparatus, as aforesaid, that is easy to use and inexpensive to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a mobile waterstop welding apparatus, according to a preferred embodiment of the present invention, illustrating a first and second support member in a closed configuration and a plurality of clamping members partially coupled to the first and second support members;

FIG. 2 is a perspective view of the mobile waterstop welding apparatus, as in FIG. 1, illustrating the first and second support members in a loading configuration with a first and second waterstop section secured to respective first and second support members with a plurality of clamping members;

FIG. 3 is a perspective view of the mobile waterstop welding apparatus, taken from a different angle as FIG. 2, illustrating the first and second support members in a heating configuration and a heating iron positioned between the first and second waterstop sections;

FIG. 4 is a perspective view of the mobile waterstop welding apparatus, as in FIG. 3, showing the first and second support members in a welding configuration;

FIG. 5 is a perspective view of the mobile waterstop welding apparatus, taken from a different angle as FIG. 1, showing the first and second support members in a closed configuration;

FIG. 6 is a perspective view of the mobile waterstop welding apparatus, as in FIG. 5, showing the first and second support members in an open configuration;

FIG. 7 is a perspective view of the mobile waterstop welding apparatus, taken from a different angle as FIG. 1, illustrating a pair of hanging members coupled to a pair of hanging elements and hanging from rebar; and

FIG. 8 is a perspective view of the mobile waterstop welding apparatus, as in FIG. 2, illustrating a pair of clamping straps and a pair of clamping blocks securing the first and second waterstop sections to respective first and second support members.

### DESCRIPTION OF THE PREFERRED EMBODIMENT

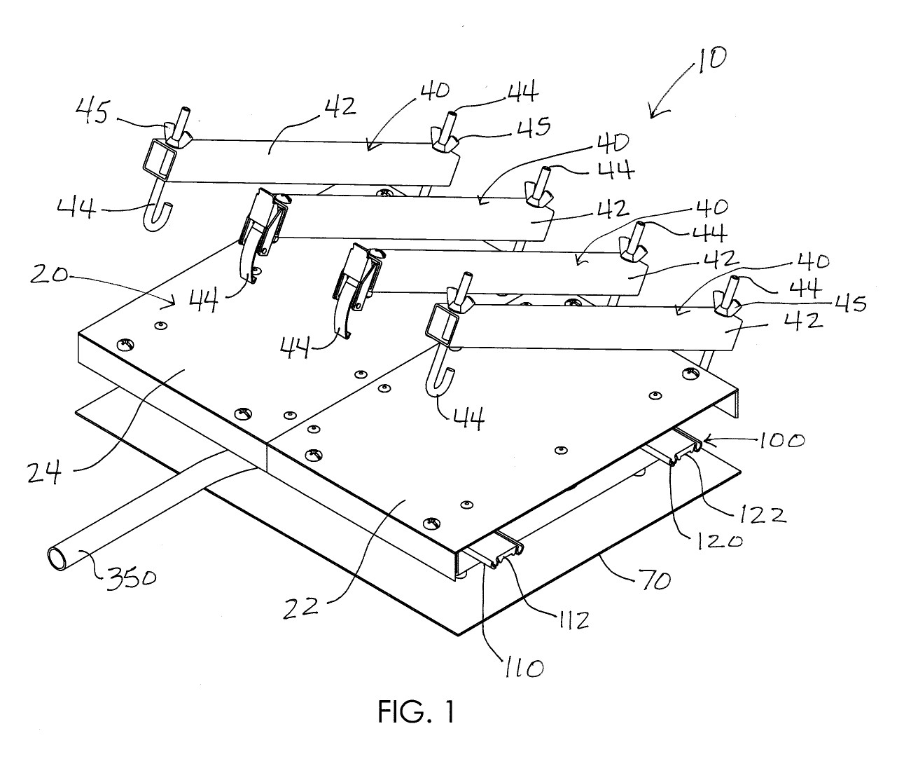

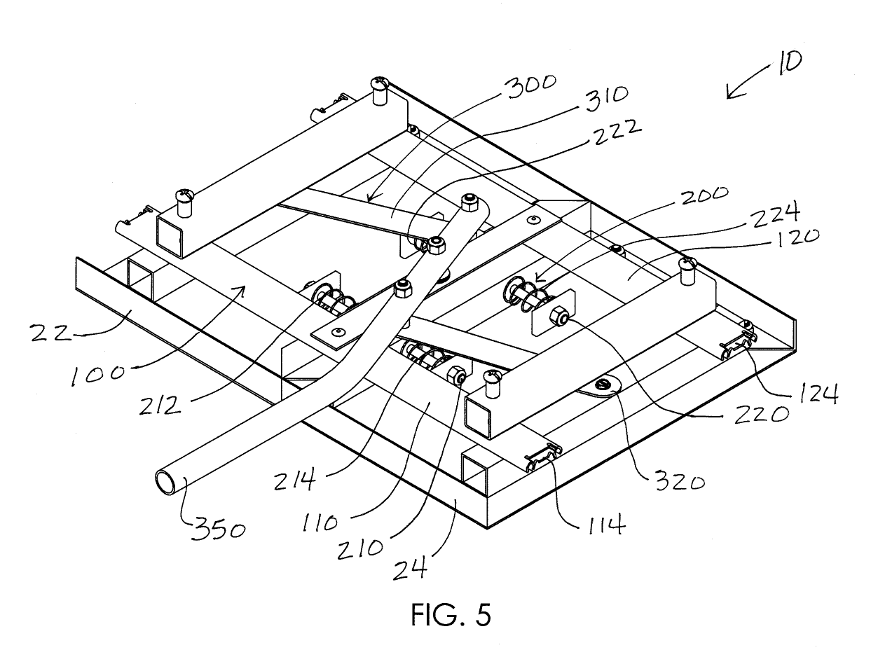

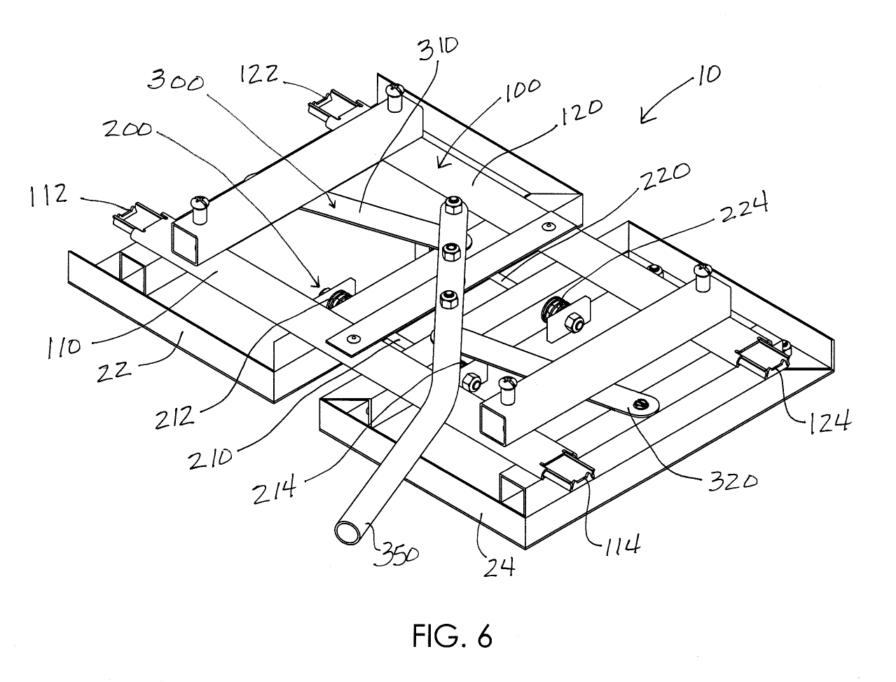

A mobile waterstop welding apparatus according to a preferred embodiment of the present invention will now be described with reference to FIGS. 1 to 8 of the accompanying drawings. The mobile waterstop welding apparatus 10 includes a support assembly 20 configured to support respective welding ends 36 of first 32 and second 34 waterstop sections. The first waterstop section 32 and/or the second waterstop section 34 may be located at a construction site and positioned in-between rebar.

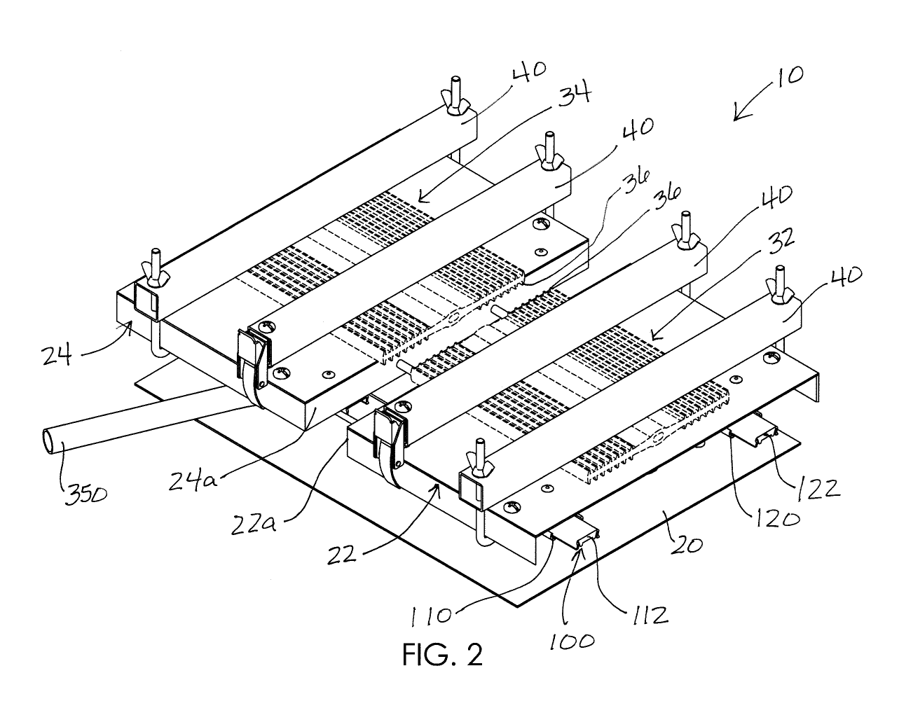

The mobile waterstop welding apparatus 10 includes first 22 and second 24 support members. The second support member 24 is operatively coupled to the first support member 22 and movable between a closed configuration (FIG. 1) and a variety of open configurations, including a loading configuration, a heating configuration, and a welding configuration. The first support member 22 may also be moveable between a closed configuration, a loading configuration, a heating configuration, and/or a welding configuration. In the closed configuration, an inner edge 22a of the first support member 22 may touch an inner edge 24a of the second support member 24. The distance between respective inner edges 22a, 24a of the first 22 and second 24 support members is measurably greater when the first 22 and second 24 support members are in an open configuration (FIG. 2) than when the first 22 and second 24 support members are in the closed configuration (FIG. 1).

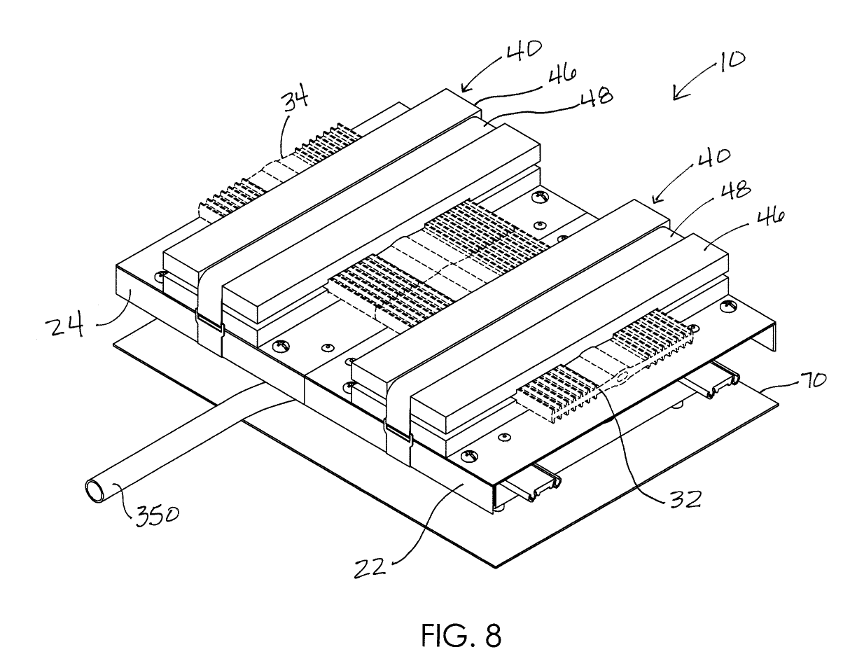

In the loading configuration, the first 22 and second 24 support members are spaced apart so as to allow respective welding ends 36 of the first 32 and second 34 waterstop sections to hang over respective inner edges 22a, 24a of respective first 22 and second 24 support members. Clamping members 40 may be selectively coupled to the first 22 and second 24 support members to secure the first 32 and second 34 waterstop sections to the first 22 and second 24 support members, respectively. In one embodiment, a clamping member 40 includes a clamping bar 42 and at least one clamping connector 44 coupled to the clamping bar 42 and selectively and releasably coupled to the first 22 or second 24 support member. The clamping connector 44 may be tightened or loosened with a fastener 45 such as a wing nut or the like. It is understood that the clamping connects may include clamps, latches, hooks, or other suitable fasteners. In another embodiment, a clamping member 40 includes a clamping block 46 and a clamping strap 48 coupled to the clamping block and the first 22 or second 24 support member (FIG. 8).

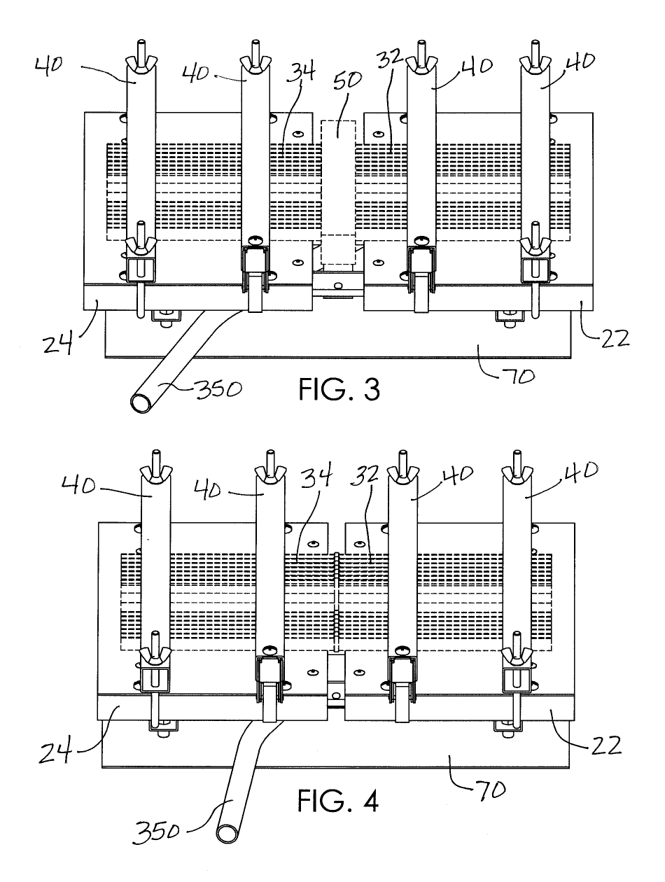

In the heating configuration, the first 32 and second 34 waterstop sections are spaced apart so that their respective welding ends 36 may be contacted together by the heating iron 50 (FIG. 3). While in this configuration, the heating iron 50 heats respective welding ends 36 of the first 32 and second 34 waterstop sections. To ensure constant contact of the welding ends 36 of the first 32 and second 34 waterstop sections with the heating iron 50, the second support member 24 may be urged towards the first support member 22, either manually or automatically.

In the welding configuration, respective welding ends 36 of the first 32 and second 34 waterstop sections contact each other (FIG. 4). If the waterstop sections are hot enough, they will be welded together. As the first 32 and second 34 waterstop sections are welded together, the second support member 24 may be urged towards the first support member 22, either manually or automatically, so as to create a more effective weld.

A track assembly 100, a spring assembly 200, and/or a linkage assembly 300 may be operatively coupled to the first 22 and second 24 support members. As will be explained below in more detail, the linkage assembly 300 may move the first 22 and second 24 support members between the loading configuration, the heating configuration, and/or the welding configuration; the spring assembly 200 may urge the first 22 and second 24 support members towards the closed configuration; and the track assembly 100 may guide the first 22 and second 24 support members as they are moved between the loading configuration, the heating configuration, and/or the welding configuration.

The track assembly 100 may include a first 110 and second 120 track member operatively coupled to the first 22 and second 24 support members. The first track member 110 may be displaced from and parallel to the second track member 120. The track assembly may also include a first 112 and third 122 slide member coupled to the first support member 22 and a second 114 and fourth 124 slide member coupled to the second support member 24. The first 112 and second 114 slide members may be in communication with the first track member 110. The third 122 and fourth 124 slide members may be in communication with the second track member 120. The slide members enable the first 22 and second 24 support members to be moved selectively between open and closed configurations.

The spring assembly 200 may include first 212 and third 222 springs operatively coupled to the first support member 22 and configured so as to urge the first 22 and second 24 support members towards the closed configuration. The spring assembly may also include second 214 and fourth 224 springs operatively coupled to the second support member 24. A first 210 and second 220 plunger may be operatively coupled to the first 22 and second 24 support members. The first plunger 210 may be in communication with the first 212 and second 214 springs. The second plunger 220 may be in communication with the third 222 and fourth 224 springs.

The linkage assembly 300 may include first 310 and second 320 linkage members coupled to the first 22 and second 24 support members, respectively, such that movement of the first 310 and second 320 linkage members causes the first 22 and second 24 support members to move along corresponding elements of the track assembly 100. A handle 350 may be coupled to the first 310 and second 320 linkage members so as to provide a mechanical advantage for moving the first 22 and second 24 support members between the closed configuration, the loading configuration, the heating configuration, and/or the welding configuration. More particularly, a user may utilize the handle 350 to easily move the support members 22, 24 between the configurations described above.

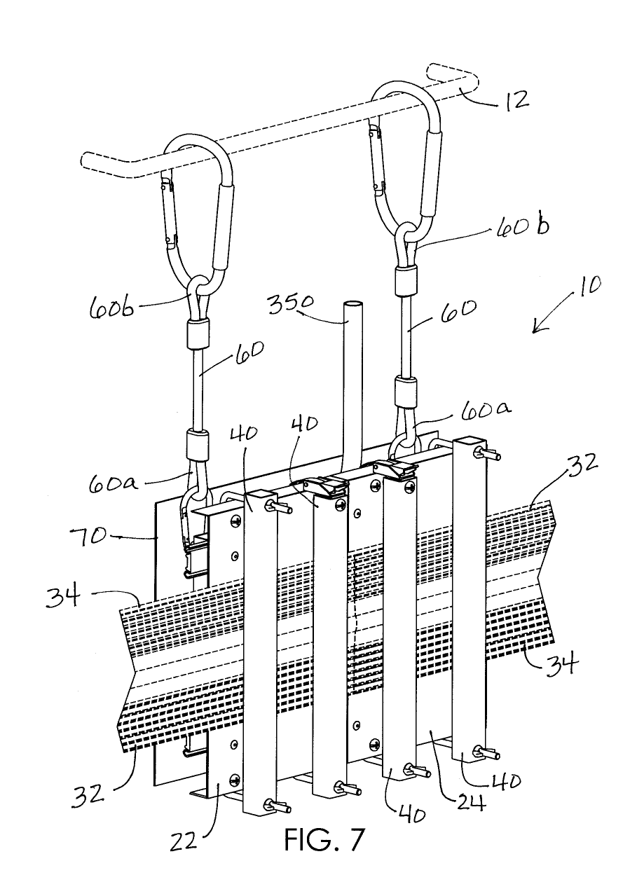

A plurality of hanging members 60 may be selectively coupled to the first 22 and second 24 support members such that the mobile waterstop welding apparatus 10 may be selectively hung from a support structure 12 such as rebar. In one embodiment (shown in FIG. 7), a single hanging member 60 may be coupled to each support member 22, 24, respectively and extend away therefrom and configured for selective attachment to the support structure 12. A back plate 70 may be coupled to the first 22 and second 24 support members so as to prevent the support structure 12 from interfering with the movement of the first 22 and second 24 support members. More particularly, each hanging member 60 may include a first end 60a coupled to the back plate 70, a respective support member, or other suitable structure, and a second end 60b having a fastener, such as a latch, carabineer, or the like configured to be releasably coupled to rebar.

In use, a person utilizes the handle 350 to cause the linkage assembly 300 to move the first 22 and second 24 support members to the loading configuration (at which ends 22a and 24a of respective support members 22, 24 are spaced apart). A spacing member (not shown) may be positioned between respective first 22 and second 24 support members to maintain their respective positions. After the first 32 and second 34 waterstop sections are loaded onto respective first 22 and second 24 support members and secured with clamping members 40, the handle 350 may be used to move the first 22 and second 24 support members out of the loading configuration so that the spacing member (not shown) may be removed.

While using the handle 350 to hold the first 22 and second 24 support members in the open configuration, a heating iron 50 may be placed between respective welding ends 36 of the first 32 and second 34 waterstop sections (FIG. 3). The handle 350 may then be used to move the first 22 and second 24 support members to the heating configuration. Upon releasing the handle 350, the spring assembly 200 may urge the first 22 and second 24 support members towards the closed configuration such that respective welding ends 36 of the first 32 and second 34 waterstop sections maintain constant contact with the heating iron 50.

Upon heating respective welding ends 36 of the first 32 and second 34 waterstop sections, the handle 350 may be used to move the first 22 and second 24 support members to the open configuration so that the heating iron 50 may be removed. The handle 350 may then be used to move the first 22 and second 24 support members to the welding configuration (FIG. 4). Upon releasing the handle 350, the spring assembly 200 may urge the first 22 and second 24 support members towards the closed configuration so as to create a more effective weld. In addition, the entire apparatus may be hung from rebar or another support structure 12 at the worksite where a waterstop weld is desired, as described above and shown in FIG. 7.

It is understood that while certain forms of this invention have been illustrated and described, it is not limited thereto except insofar as such limitations are included in the following claims and allowable functional equivalents thereof.

1. A mobile waterstop welding apparatus for use in welding together a first waterstop section to a second waterstop section using a waterstop iron, comprising:
a first support member configured to support the first waterstop section;
a second support member configured to support the second waterstop section, said second support member being operatively coupled to said first support member and movable between:
a loading configuration at which said first and said second support members are spaced apart to selectively allow respective first and second waterstop sections to be coupled to respective first and second support members;
a heating configuration allowing the first and second waterstop sections to be simultaneously heated by the waterstop iron; and
a welding configuration allowing the first and second waterstop sections to be welded together after they have been heated by the waterstop iron; and
a plurality of clamping members for selectively coupling respective first and second waterstop sections to said first and second support members.

2. The mobile waterstop welding apparatus of claim 1, wherein the first and second waterstop sections are selectively located at a construction site and positioned in-between rebar.

3. The mobile waterstop welding apparatus of claim 2, further comprising a track assembly operatively coupled to said first and second support members that is configured to guide said second support member as it moves between respective loading, heating, and welding configurations.

4. The mobile waterstop welding apparatus of claim 3, further comprising a spring assembly operatively coupled to said first and second support members that is configured to urge the second waterstop section towards the first waterstop section when said second support member is in the welding configuration.

5. The mobile waterstop welding apparatus of claim 4, further comprising a linkage assembly coupled to said first and second support members.

6. The mobile waterstop welding apparatus of claim 3, further comprising a handle operatively coupled to said first and said second support members and configured such that movement of said handle causes said second support member to travel along said track assembly.

7. The mobile waterstop welding apparatus of claim 1, comprising a hanging member selectively coupled to each of said first and said second support member, respectively, said hanging member having a free end configured to selectively attach to the rebar.

8. The mobile waterstop welding apparatus of claim 7, further comprising a back plate coupled to and displaced from said first and second support members.

9. The mobile waterstop welding apparatus of claim 8, wherein said first support member is movable between:
a loading configuration at which said first and said second support members are spaced apart so as to allow respective first and second waterstop sections to be coupled to respective first and second support members, respectively;
a heating configuration at which said first and said second support members are spaced apart so as to so as to allow respective ends of the first and second waterstop sections to be simultaneously heated by the waterstop iron; and
a welding configuration allowing the first and second waterstop sections to be welded together after they have been heated by the waterstop iron.

10. The mobile waterstop welding apparatus of claim 9, wherein said track assembly includes:
a first and third slide member coupled to said first support member;
a second and fourth slide member coupled to said second support member;
a first track member slidably coupled to said first and third slide members; and
a second track member slidably coupled to said second and fourth slide members.

11. The mobile waterstop welding apparatus of claim 10, wherein said spring assembly includes:
a first and third spring operatively coupled to said first support member and configured so as to urge said first and second support members towards the closed configuration;
a second and fourth spring operatively coupled to said second support member and configured so as to urge said first and second support members towards the closed configuration;
a first plunger in communication with said first and third springs; and
a second plunger in communication with said second and fourth springs.

12. The mobile waterstop welding apparatus of claim 11, wherein at least one of said clamping members includes at least one of the following:
a clamping bar having at least one clamping connector configured to selectively couple said clamping bar to said first or second support member; or
a clamping block and a clamping strap, said clamping strap being selectively coupled to said clamping block so as to selectively couple said clamping block to said first or second support member.

13. A mobile waterstop welding apparatus for use in welding together a first waterstop section to a second waterstop section using a waterstop iron, comprising:
a first support member configured to support the first waterstop section;
a second support member configured to support the second waterstop section, said second support member being operatively coupled to said first support member and movable between:
a loading configuration at which said first and said second support members are spaced apart so as to allow respective first and second waterstop sections to be releasably coupled to respective first and second support members;
a heating configuration allowing the first and second waterstop sections to be simultaneously heated by the waterstop iron; and
a welding configuration allowing the first and second waterstop sections to be welded together after they have been heated by the waterstop iron; and
a plurality of hanging members selectively coupled to said first and second support members.

14. The mobile waterstop welding apparatus of claim 13, comprising a track assembly operatively coupled to said first and second support members that is configured to guide said second support member as it moves between respective loading, heating, and welding configurations, said track assembly including:
a first and third slide member coupled to said first support member;
a second and fourth slide member coupled to said second support member;
a first track member slidably coupled to said first and third slide members; and
a second track member slidably coupled to said second and fourth slide members.

15. The mobile waterstop welding apparatus of claim 13, comprising a spring assembly operatively coupled to said first and said second support member so as to urge the second waterstop section towards the first waterstop section when said second support member is in the welding configuration, said spring assembly including:
a first and third spring operatively coupled to said first support member and configured so as to urge said first and second support members towards the closed configuration;
a second and fourth spring operatively coupled to said second support member and configured so as to urge said first and second support members towards the closed configuration;
a first plunger in communication with said first and third springs; and
a second plunger in communication with said second and fourth springs.

16. The mobile waterstop welding apparatus of claim 13, comprising:
a linkage assembly having a first linkage member coupled to said first support member and a second linkage member coupled to said second support member; and
a handle coupled to said first and second linkage members of said linkage assembly.

17. The mobile waterstop welding apparatus of claim 13, comprising a plurality of clamping members for selectively coupling the first and second waterstop sections to said first and second support members, respectively.

18. The mobile waterstop welding apparatus of claim 17, wherein at least one of said clamping members includes at least one of the following:
a clamping bar having at least one clamping connector to selectively couple said clamping bar to said first or second support member; or
a clamping block and a clamping strap, said clamping strap being selectively coupled to said clamping block so as to selectively couple said clamping block to said first or second support member.

19. A mobile waterstop welding apparatus for use in welding together a first waterstop section to a second waterstop section using a waterstop iron, comprising:
a first support member configured to support a first waterstop section;
a second support member configured to support a second waterstop section, said second support member being operatively coupled to said first support member and movable between:
a closed configuration at which said first support member is in contact with said second support member;
a loading configuration at which said first support member is spaced apat from said second support member so as to allow respective first and second waterstop sections to be coupled to respective first and second support members;
a heating configuration allowing the first and second waterstop sections to be simultaneously heated by the waterstop iron; and
a welding configuration allowing the first and second waterstop sections to be welded together after they have been heated by the waterstop iron;
a back plate coupled to said first and second support members; and
a plurality of hanging members selectively coupled to said first and second support members.

20. The mobile waterstop welding apparatus of claim 19, further comprising:
a track assembly operatively coupled to said first and second support members;
a spring assembly operatively coupled to said first and second support members that is configured to normally urge the second waterstop section towards the first waterstop section when said second support member is in the welding configuration;
a linkage assembly having a first linkage member coupled to said first support member and a second linkage member coupled to said second support member; and
a handle coupled to said first and second linkage members of said linkage assembly and operatively coupled to said first and said second support members such that movement of said handle causes said second support member to travel along said track assembly.
